(19) United States
(12) Patent Application Publication
(10) Pub. No.: US 2010/0132841 A1
(43) Pub. Date: Jun. 3, 2010

(54) FINGER JOINT CUTTER

(75) Inventors: Seizo Itaya, Aichi (JP); Atsushi Tsuchiya, Niwa-gun (JP)

Correspondence Address: Quinn Emanuel Urquhart & Sullivan, LLP, 865 S. FIGUEROA STREET, 10TH FLOOR, LOS ANGELES, CA, 90017, US

(73) Assignee: Kanefusa Kabushiki Kaisha

(21) Appl. No.: 12/452,538

(22) PCT Filed: Jul. 27, 2007
(86) PCT No.: PCT/JP2007/064816

§ 371 Date: Jan. 7, 2010

(51) Int. Cl. B27F 1/16; B27G 13/14

(52) U.S. Cl. 144/237

(57) ABSTRACT

A finger joint cutter is provided that inhibits occurrence of a blow out or a rip out and has a good cutting accuracy. The finger joint cutter is provided with a plurality of blade array groups 44a to 44d made of a plurality of cutting blades 14 aligned at a predetermined pitch L along a rotary shaft R to shave joint fingers by allowing the cutting blades 14 to cut into an end portion of a material to be cut at the same time. The cutting blades 14 are constituted from either a main blade 46 or an auxiliary blade 48. A rake face 50 of the main blade 46 is formed in an angle shape being tapered off towards an outer diameter. A width dimension l₁ of a rake face 54 of the auxiliary blade 48 parallel to the rotary shaft R is set to be smaller than a width dimension l₂ of the rake face 50 of the main blade 46 parallel to the rotary shaft R. The pitch L is set to be not less than the width dimension l₂ of the main blade 46. Further, the main blade 46 is provided to be adjacent to the auxiliary blade 48 along the rotary shaft R and also not to be adjacent to the main blade 46 with each other along the rotary shaft R.

### TECHNICAL FIELD

The present invention relates to a finger joint cutter, and more particularly to a finger joint cutter that can cut well without occurrence of a defect, a crack, or the like on an outer surface in the vicinity of a valley portion and at a pointed end portion of fingers for joint (hereinafter, referred to as “joint fingers”).

### BACKGROUND ART

As a means of effectively utilizing thinned woods of small diameter woods and surplus boards borne upon cutting out a solid wood, manufacture of laminated lumbers by a finger joint system is widely carried out. The finger joint system is a method to obtain a long joint material by cutting the above surplus board or thinned wood into a rectangular wood board having, for example, a width of 50 mm, a thickness of 20 mm, and an arbitrary length, and then shaving joint fingers in the form of fingers of a hand at both cut ends of the wood board (material to be cut) with a cutting blade each provided on a projecting tooth of a finger joint cutter, and sequentially engaging the fingers for joint of each wood board with each other via an adhesive, followed by longitudinally compressing for joint.

Finger joint cutters used in conventional finger joint systems are roughly categorized into two types. One of them is, as illustrated in FIG. 8(a), a finger joint cutter 16 (hereinafter, referred to as “same phase type”) in which cutting blades 13 are arranged, continuously along a rotary shaft R, the cutting blades provided on projecting teeth 42 projecting approximately radially on the outer periphery of a body 12 having a shaft hole 10 for inserting a rotary shaft opened therein and shaving a groove portion 37 between joint fingers 24, 24 (see FIG. 9), and the other is, as illustrated in FIG. 8(b), a finger joint cutter 18 (hereinafter, referred to as “different phase type”) in which cutting blades 13 are arranged alternately along the rotary shaft R. In the description below, when a trajectory of the cutting blades 13 drawn by rotation is called as “rotation trajectory plane”, the finger joint cutter 16 of the same phase type illustrated in FIG. 8(a) is provided with four cutting blades 13 on an identical rotation trajectory plane, whereas the finger joint cutter 18 of the different phase type illustrated in FIG. 8(b) is provided with two cutting blades 13 on an identical rotation trajectory plane, and cutting blades 13 on adjacent rotation trajectory planes are arranged with a phase difference of 90° from each other. In FIG. 8(b), the cutting blades 13 illustrated with solid lines represent those provided on an identical rotation trajectory plane, and the cutting blades 13 illustrated with dash-dotted lines represent those provided on another rotation trajectory plane adjacent to each other.

Also in either type of the finger joint cutters 16, 18 described above, each cutting blade 13 has a rake face 20 thereof formed in an angle shape being tapered off towards the outer diameter and shaves the joint fingers 24, 24 in the form of fingers of a hand at a cut end of a material to be cut (material to be cut) 32 with scarf portions 28, 28, which are raked portions, and an blade end 22 thereof as illustrated in FIG. 9. That is, the blade end 22 and the scarf portions 28, 28 of the cutting blade 13 serve for cutting a valley portion 26 of the joint fingers 24 and slope portions 30, 30 of the joint fingers 24, respectively.

FIG. 10 are explanatory diagrams for illustration of the conditions of cutting the material 32 to be cut by the same phase type and different phase type finger joint cutters 16, 18 in comparison. As illustrated in FIG. 10(a), regarding the cutting blades 13 on an identical rotation trajectory plane of the same phase type finger joint cutter 16, the cutter rotates a quarter from when a cutting blade of the first cut (first cutting blade 13a) comes until when the next cutting blade (second cutting blade 13b) comes. In contrast, as illustrated in FIG. 10(b), taking an identical rotation trajectory plane as a standard regarding the different phase type finger joint cutter 18, the cutter 18 needs to rotate a half from when the first cutting blade 13a comes until when the next second cutting blade 13b comes. The diagram at the center of FIG. 10(b) is a state of cutting the material 32 to be cut with a cutting blade 13 on another rotation trajectory plane (illustrated with dash-dotted lines).

That is, since the same phase type finger joint cutter 16 has a shorter period from when an arbitrary cutting blade 13 comes until when the next cutting blade 13 comes to a cutting position (hereinafter, referred to as “cutting period”) compared to the cutting period of the different phase type finger joint cutter 18, the amount of movement (amount of feeding material) of the material 32 to be cut therebetween becomes small (in a case of FIG. 10, the amount of movement becomes approximately half compared to that of the different phase type). The same phase type finger joint cutter 16 can therefore cut the material 32 to be cut finely in a short cycle in a number of times, so that a load applied to the material 32 to be cut by one cutting blade 13 in one time of cutting becomes approximately half compared to that of the different phase type. Although a blow out A (see FIG. 9) is easily produced that causes the cutting blades 13, at an excessively high feeding speed, to catch a portion less in strength of the material 32 to be cut, upon coming off (disengaging) from the material 32 to be cut, and to break, in particular, around the valley portion 26 of the joint fingers 24 in an outer surface of the material 32 to be cut, the same phase type finger joint cutter 16 having a shorter cutting period would enable to greatly inhibit occurrence of such a defect.

The same phase type finger joint cutter 16 however has the following disadvantages. As illustrated in FIG. 8(a), since the cutting blades 13 are disposed continuously along the rotary shaft R in the same phase type finger joint cutter 16, a valley (hereinafter, referred to as “blade bottom portion 34”) defined by the scarf portions 28, 28 of both cutting blades 13, 13 becomes an extremely narrow streak form that is sharply cut. Therefore, wood chips borne during cutting the material 32 to be cut are easily accumulated in compression in this narrow blade bottom portion 34 (hereinafter, referred to as “accumulated portion C”), and the accumulated portion C comes into contact with any of the joint fingers 24 shaved during cutting, to sometimes cause a defect (hereinafter, such a defect is referred to as “rip out”) at a pointed end portion 36 of the joint finger 24. That is, in a case of cutting the material 32 to be cut by the same phase type finger joint cutter 16, as illustrated in FIG. 9, there has been a difficulty of easy occurrence of a rip out B at a pointed end of the joint finger 24. Accordingly, in Patent Document 1, a finger joint cutter that discharges the wood chips well in the blade bottom portions 34 is proposed, in order to inhibit the occurrence of the rip out B, by raising the blade bottom portion 34 between the cutting blades 13, 13 in a predetermined dimension to form blade bottom portions 34 with an enlarged width as much as possible (not shown). Accumulation of wood chips in the blade bottom portion 34 is thus inhibited to some extent, and in particular, it exhibits a certain effect in processing of plywood (chipboards) and particle boards, that has been conventionally difficult to shave the joint fingers 24.

Thus, according to the finger joint cutter of Patent Document 1, while plywood and particle boards, which has been difficult to shave the joint fingers 24, becomes possible to have the joint fingers 24 shaved therein, the accumulation of wood chips in the blade bottom portions 34 is not completely solved and it has to be expressed as insufficient to shave the joint fingers 24 of good quality in a solid wood without reducing production efficiency.

Moreover, the cutting blade 13 needs to be provided with the scarf portions 28, 28 having a certain length, so that there is a limitation in enlargement of the bottom portion. Therefore, it has been impossible to form a bottom portion, in the blade bottom portion 34, with a dimension necessary and sufficient to well discharge wood chips of a solid wood. Accordingly, in a case of cutting the material 32 to be cut of a solid wood, the different phase type finger joint cutter 18 has been used that can widely secure the blade bottom portions 34 as illustrated in FIG. 8(b).

### Patent Document 1: Japanese Unexamined Patent Publication No. 2005-280081

### DISCLOSURE OF INVENTION

### Problems to be Solved by the Invention

In recent years, from the perspective of improvement in processing efficiency, it is desired to speed up the feeding speed of the material 32 to be cut. However, as the feeding speed of the material 32 to be cut is raised, the amount to be cut particularly with the blade end 22 becomes large, so that the load on the valley portion 26 of the material 32 to be cut increases. Therefore, at a high speed of feeding materials, even the material 32 to be cut of a solid wood cannot bear the load during cutting, which give rise to the problem of producing a blow out A described above.

Accordingly, there is no choice but to decrease the amount of being cut with the blade end 22 in order to inhibit occurrence of such a blow out A, and there is an increasing request for use of the same phase type finger joint cutter 16, which has a shorter cutting period, even for the material 32 to be cut of a solid wood. However, as described above, in a case of using the same phase type finger joint cutter 16, in which the cutting blades 13 are arranged close along the rotary shaft R, for the material 32 to be cut of a solid wood, it is required to inhibit occurrence of the rip out B due to the accumulation of wood chips in the blade bottom portions 34 as described above. Accordingly, the present inventors have made a keen study for improvement in further enlargement of the blade bottom portions 34 between the cutting blades 13, 13 in the same phase type finger joint cutter 16.

That is, in view of the problems inherent in the conventional techniques described above, the present invention is proposed to solve them appropriately, and in particular, an object of the present invention is to provide a finger joint cutter that can appropriately inhibit occurrence of a blow out or a rip out upon shaving joint fingers in a solid wood.

### Means for Solving the Problems

In order to solve the problem described above and achieve the desired object appropriately, a finger joint cutter according to the present invention includes a plurality of blade array groups made of a plurality of cutting blades aligned at a predetermined pitch along a rotary shaft, the cutting blades of each blade array group in rotation cutting into an end portion of a material to be cut at a same time per blade array group and thereby shaving a plurality of joint fingers aligned at an identical pitch at the end portion of the material to be cut, wherein

the cutting blades are either a main blade shaving a valley portion and a slope portion of the joint fingers or an auxiliary blade shaving in proximity to the valley portion of the joint fingers,

the main blade has a rake face in an angle shape being tapered off towards an outer diameter,

the auxiliary blade is set to have a rake face with a width dimension parallel to the rotary shaft in a portion on an inner diameter side being smaller than a width dimension parallel to the rotary shaft in a portion on the inner diameter side in the rake face of the main blade,

the pitch is set to be not less than the width dimension of the main blade, and

the main blade is provided to be adjacent to the auxiliary blade along the rotary shaft and also not to be adjacent to the main blade with each other along the rotary shaft.

According to the subject matter of claim 1, since the auxiliary blade or the main blade is provided in a same phase, the valley portion of the joint fingers can be cut continuously in a shorter cutting period with both ends of the main blade and the auxiliary blade. Therefore, the load on the valley portion of the joint fingers becomes small and occurrence of a blow out is inhibited effectively. Moreover, since the width dimension of the rake face of the auxiliary blade parallel to the rotary shaft is made smaller, the blade bottom portion between the main blade and the auxiliary blade is enlarged for an improvement in the effect of discharging wood chips, and thus occurrence of a rip out can be reduced.

In the finger joint cutter according to claim 2, the blade array groups have the plurality of cutting blades configured integrally and arranged on an outer periphery of a main body having a shaft hole for inserting a rotary shaft opened therein for each of the blade array groups.

According to the subject matter of claim 2, in a finger joint cutter of a so-called solid type, the effect of inhibiting a rip out or a blow out can be improved.

In the finger joint cutter according to claim 3, the cutting blades are provided individually on outer peripheries of unit cutters having a shaft hole for inserting a rotary shaft opened therein and having a thickness identical to the pitch, and a plurality of the unit cutters are stacked to constitute the blade array groups with each of the cutting blades being aligned along the rotary shaft.

According to the subject matter of claim 3, in a finger joint cutter provided with a plurality of unit cutters of a so-called separate type, the effect of inhibiting a rip out or a blow out can be improved.

In the finger joint cutter according to claim 4, the main blade and the auxiliary blade have a blade bottom portion defined therebetween with a width dimension parallel to the rotary shaft being set to be larger than a width dimension at blade ends of the main blade and the auxiliary blade parallel to the rotary shaft.

According to the subject matter of claim 4, the width of the blade bottom portion is made wider than the end of the cutting blade, and thus the effect of discharging wood chips can be improved.

### EFFECT OF THE INVENTION

According to the finger joint cutter of the present invention, occurrence of a blow out or a rip out can be inhibited and finger joint processing of good quality can be applied to a material to be cut.

### BRIEF DESCRIPTION OF DRAWINGS

FIG. 1 is a schematic plan view illustrating a finger joint cutter according to an embodiment.

FIG. 2 are schematic explanatory diagrams for blade array groups of the finger joint cutter taken from a rake face, wherein FIG. 2(a) illustrates the first and third blade array groups and FIG. 2(b) illustrates the second and fourth blade array groups.

FIG. 3 are explanatory diagrams illustrating conditions of cutting by the finger joint cutter, wherein FIG. 3(a) illustrates a state of cutting with the first blade array group, FIG. 3(b) illustrates a state of cutting with the second blade array group, and FIG. 3(c) illustrates a state of cutting with the third blade array group.

FIG. 4 is a schematic plan view illustrating a finger joint cutter according to a modification.

FIG. 5 is a schematic explanatory diagram for a blade array group of a finger joint cutter according to a modification taken from a rake face.

FIG. 6 is a schematic explanatory diagram for a blade array group of a finger joint cutter according to a modification taken from a rake face.

FIG. 7 is a schematic explanatory diagram for a blade array group of a finger joint cutter according to a modification taken from a rake face.

FIG. 8 are schematic plan views illustrating conventional finger joint cutters, wherein FIG. 8(a) illustrates a same phase type finger joint cutter and FIG. 8(b) illustrates a different phase type finger joint cutter.

FIG. 9 is a schematic view illustrating a material to be cut in which joint fingers are shaven at an end portion.

FIG. 10 are schematic explanatory diagrams illustrating conditions of cutting by the conventional finger joint cutters, wherein FIG. 10(a) illustrates that by the same phase type finger joint cutter and FIG. 10(b) illustrates that by the different phase type finger joint cutter.

FIG. 11 is a schematic explanatory diagram for a blade array group of a finger joint cutter according to a modification taken from a rake face.

### BEST MODE FOR CARRYING OUT THE INVENTION

Next, a description is given below to a finger joint cutter according to the present invention by way of a preferred embodiment with reference to the accompanying drawings. In this embodiment, a description is given for an example of a finger joint cutter of a so-called solid type, in which four cutting blades are provided on each rotation trajectory plane and each cutting blade on each rotation trajectory plane is arranged in alignment along the rotary shaft. The same reference numerals are assigned to the members identical to those described in the conventional examples. It should be noted that each of the drawings referred to in the description below is drawn partially exaggerated for illustration of the present invention.

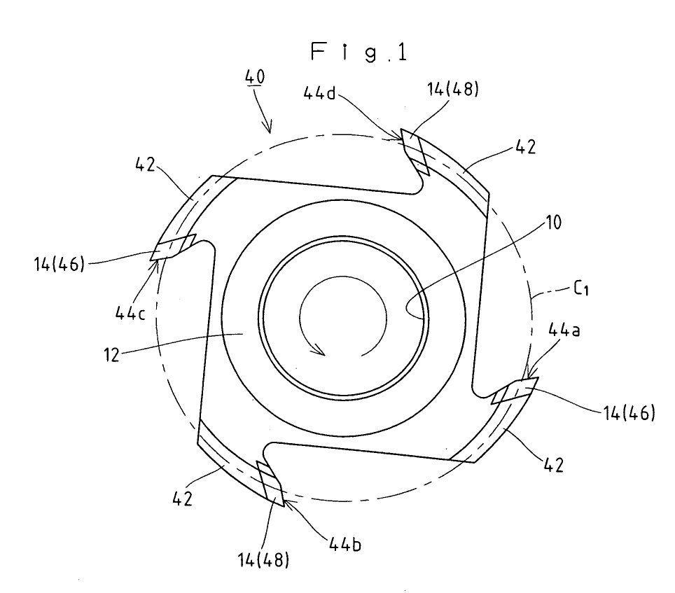

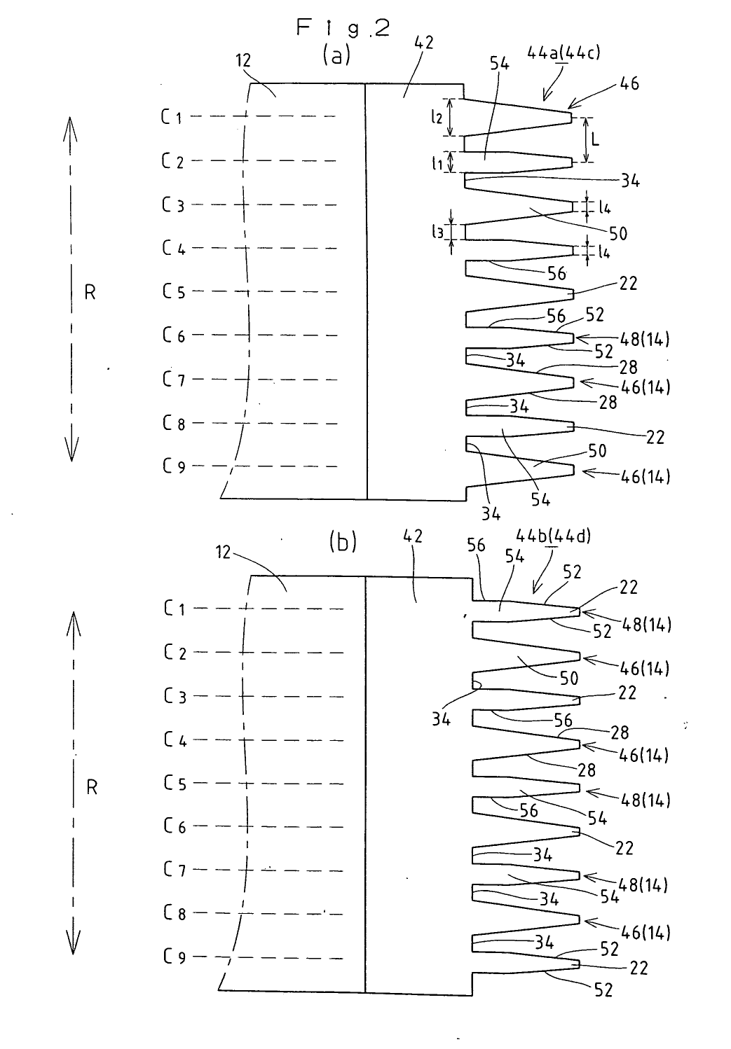

FIG. 1 is a schematic plan view illustrating a finger joint cutter 40 according to an embodiment. In this finger joint cutter 40, a plurality of projecting teeth 42 is formed integrally on the outer periphery of a body (main body) 12 having a shaft hole 10 for inserting a rotary shaft of a cutting apparatus not shown opened therein and having a thickness parallel to a rotary shaft R. As illustrated in FIG. 2, a plurality of cutting blades 14 are arranged on the projecting teeth 42 along the rotary shaft R at a predetermined pitch L (separation distance between the blade ends 22, 22) to constitute blade array groups 44a to 44d. That is, nine cutting blades 14 are configured integrally in each of the blade array groups 44a to 44d and are provided respectively on the projecting teeth 42 for each of the blade array groups 44a to 44d. The dimension of each of the blade array groups 44a to 44d parallel to the rotary shaft R is set to be identical to or slightly smaller than the dimension of the body 12 parallel to the rotary shaft R. For the convenience of description, as illustrated in FIG. 2, the nine rotation trajectory planes made by the rotating trajectory of each cutting blade 14 may be called as first to ninth rotation trajectory planes C₁ to C₉ sequentially from the top, and the cutting blades 14 (main blades 46 and auxiliary blades 48, described later) provided on each rotation trajectory plane may also be distinguished by numbering correspondingly (first to ninth). As illustrated in FIG. 1, the blade array groups 44a to 44d may also be distinguished, as needed, by assigning such names as from a first blade array group 44a to a fourth blade array group 44d in a circumferential order.

The cutting blades 14 include two types that are main blades 46 and auxiliary blades 48, and both are alternately arranged by being separated at a predetermined pitch L along the rotary shaft R, and blade bottom portions 34 are formed between the main blades 46 and the auxiliary blades 48. The main blades 46 extend from the projecting teeth 42 in the direction of the outer diameter in a predetermined amount of projection, and each has a rake face 50 thereof in an angle shape with formation of scarf portions 28, 28 enlarged from the blade end 22 towards the blade bottom portion 34. A width dimension l₂ of a base portion (portion in the inner diameter side) on the rake face 50 of the main blade 46 is set to be same as or slightly smaller than the pitch L. That is, the pitch L of the cutting blades 14 is set to be not less than the width dimension l₂ of the main blades 46. As illustrated in FIG. 2(a), in the first and third blade array groups 44a, 44c, five main blades 46 are provided in total on the first, third, fifth, seventh, and ninth rotation trajectory planes C₁, C₃, C₅, C₇, and C₉. In contrast, in the second and fourth blade array groups 44b, 44d, as illustrated in FIG. 2(b), four main blades 46 are provided in total on the second, fourth, sixth, and eighth rotation trajectory planes C₂, C₄, C₆, and C₈. That is, taking each rotation trajectory plane as a standard, two main blades 46 are provided opposingly with a phase difference of 180° (see FIG. 1).

The auxiliary blades 48 extend from the projecting teeth 42 in the direction of the outer diameter in the amount of projection identical to that of the main blades 46, and also each has short and small scarf portions 52, 52 enlarged from the blade end 22 in the direction of the inner diameter. Further in the auxiliary blade 48, parallel portions 56 are formed that are extended from the blade bottom portions 34 towards the scarf portions 52 orthogonally to the rotary shaft R. The parallel portion 56, as illustrated in FIG. 2(a), has a width dimension l₁ parallel to the rotary shaft R being set to be smaller compared to the width dimension l₂ of the main blades 46. That is, rake faces 54 of the auxiliary blades 48 are narrower and smaller than the rake faces 50 of the main blades 46, and the parallel portions 56 are not designed to contribute to the cutting of the slope portions 30 of the joint fingers 24. Therefore, the auxiliary blades 48 mainly serve for shaving around the valley portions 26 of the joint fingers 24 with the blade ends 22 thereof. The longitudinal dimension of the parallel portions 56 is set to be approximately half of the longitudinal dimension of the rake face 54 of the auxiliary blade 48. The width dimension of the blade end 22 of the auxiliary blade 48 parallel to the rotary shaft R is identical to the width dimension of the blade end 22 of the main blade 46 (hereinafter, the width dimension of both the blades ends 22 is referred to as l₄).

By thus providing the auxiliary blades 48, haying the parallel portions 56 formed therein, adjacent to the main blades 46 along the rotary shaft R and also arranging the main blades 46 not to be adjacent to each other, the blade bottom portions 34 are set to have a wide width. That is, the parallel portions 56 of the auxiliary blades 48 extend from the positions, separated a certain distance from the scarf portions 28 of the main blades 46, in the direction of the outer diameter, and large spaces are secured for the blade bottom portions 34 to improve the effect of discharging wood chips. A width dimension l₃ of the blade bottom portion 34 parallel to the rotary shaft R is larger than the width dimension l₄ of the blade end 22.

As illustrated in FIG. 2(a), four auxiliary blades 48 in the first and third blade array groups 44a, 44c are provided in total on the second, fourth, sixth, and eighth rotation trajectory planes C₂, C₄, C₆, and C₈. As illustrated in FIG. 2(b), in the second and fourth blade array groups 44b and 44d, five auxiliary blades 48 are provided in total on the first, third, fifth, seventh, and ninth rotation trajectory planes C₁, C₃, C₅, C₇, and C₉. That is, taking each rotation trajectory plane as a standard, two auxiliary blades 48 are provided opposingly with a phase difference of 90° relative to the main blades 46 (see FIG. 1). The finger joint cutter 40 according to this embodiment therefore has the main blades 46 and the auxiliary blades 48 arranged circumferentially alternately and has both cutting blades 14, 14 coming to a cutting position alternately.

### (Operation of Embodiment)

Next, a description is given below to operations of the finger joint cutter according to the present embodiment. In the following description, a description is given to a case of cutting a material 32 to be cut of a solid wood.

When an end portion of a material 32 to be cut fed at a certain feeding speed (for example, 20 m/min) comes to a cutting position, the blade ends 22 of the main blades 46 and the auxiliary blades 48 start cutting groove portions 37 of the joint fingers 24, and also the scarf portions 28, 28 of the main blades 46 shave the slope portions 30 of the joint fingers 24. It should be noted that the scarf portions 52, 52 of the auxiliary blades 48 only cut the slope portions 30 of the joint fingers 24 partially, and the slope portions 30 are mainly shaved with the scarf portions 28 of the main blades 46.

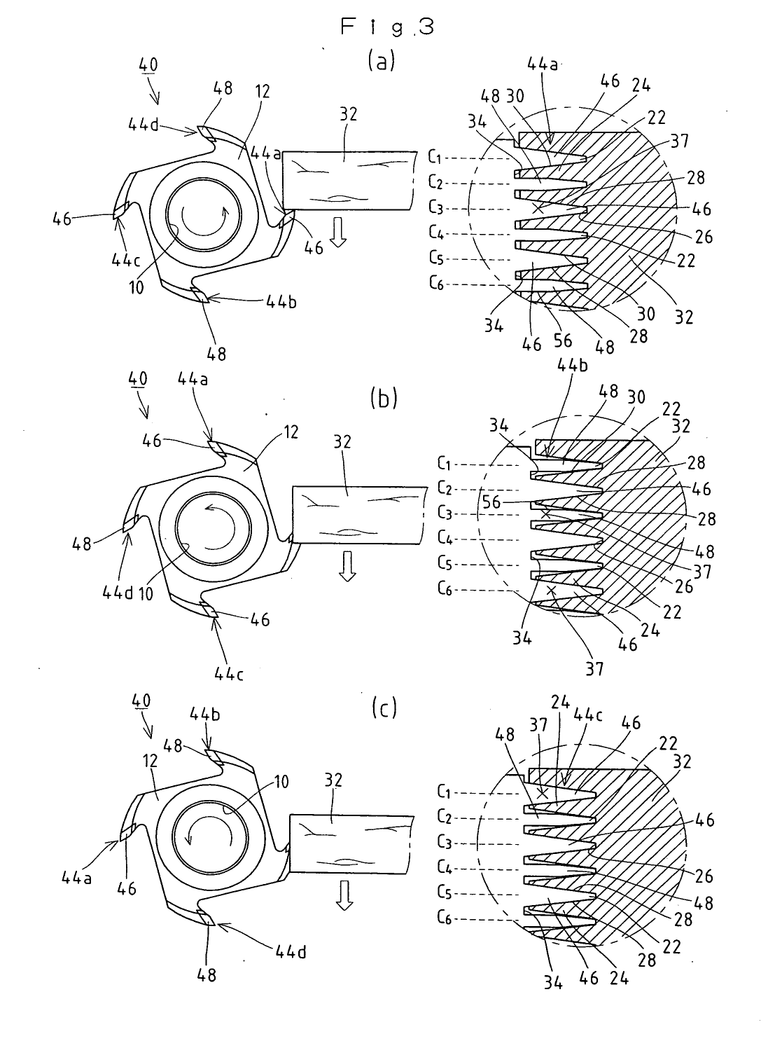

As illustrated in FIG. 3(a), cutting is considered to be made firstly with the first blade array group 44a, and when focusing, for example, on cutting with the cutting blades 14 (third main blade 46 and third auxiliary blade 48) on the third rotation trajectory plane C₃, the valley portion 26 and the slope portions 30 of the joint fingers 24 are cut in the material 32 to be cut with the third main blade 46 of the first blade array group 44a to shave the groove portion 37 in an angle shape in the material 32 to be cut. At this point, the wood chips of the material 32 to be cut borne by the cutting are not accumulated in the blade bottom portions 34, which are formed widely, and are discharged to the outside smoothly.

Subsequently, as illustrated in FIG. 3(b), when the third auxiliary blade 48 of the second blade array group 44b comes to the cutting position, the auxiliary blade 48 contributes only to the shaving of the valley portion 26 of the joint fingers 24 with the blade end 22. That is, the parallel portions 56 of the third auxiliary blade 48 pass through the groove portion 37 and do not contribute to the cutting of the slope portions 30 of the joint fingers 24. Further, as illustrated in FIG. 3(c); when the third main blade 46 of the third blade array group 44c comes to the cutting position, the valley portion 26 and the slope portions 30 of the joint fingers 24 are cut with the blade end 22 and the scarf portions 28, 28.

The valley portion 26 of the joint fingers 24 is thus subjected to a continuous cutting for every quarter rotation of the finger joint cutter 40. Therefore, the load to the valley portion 26 of the material 32 to be cut is reduced, and thus occurrence of a blow out A can be inhibited appropriately. On the other hand, the slope portions 30 of the joint fingers 24 are subjected to a cutting with the scarf portions 28, 28 of the main blades 46 for every half rotation of the finger joint cutter 40. Further, the wood chips of the material 32 to be cut borne during cutting are not accumulated in the blade bottom portions 34, which are set to have a wide width, and discharged smoothly to the outside, so that occurrence of a rip out B in the material 32 to be cut can be prevented. That is, according to the finger joint cutter 40 of this embodiment, a blow out A or a rip out B does not occur even for the material 32 to be cut of a solid wood fed at a high speed, and thus a higher cutting accuracy can be exhibited.

### (Modifications)

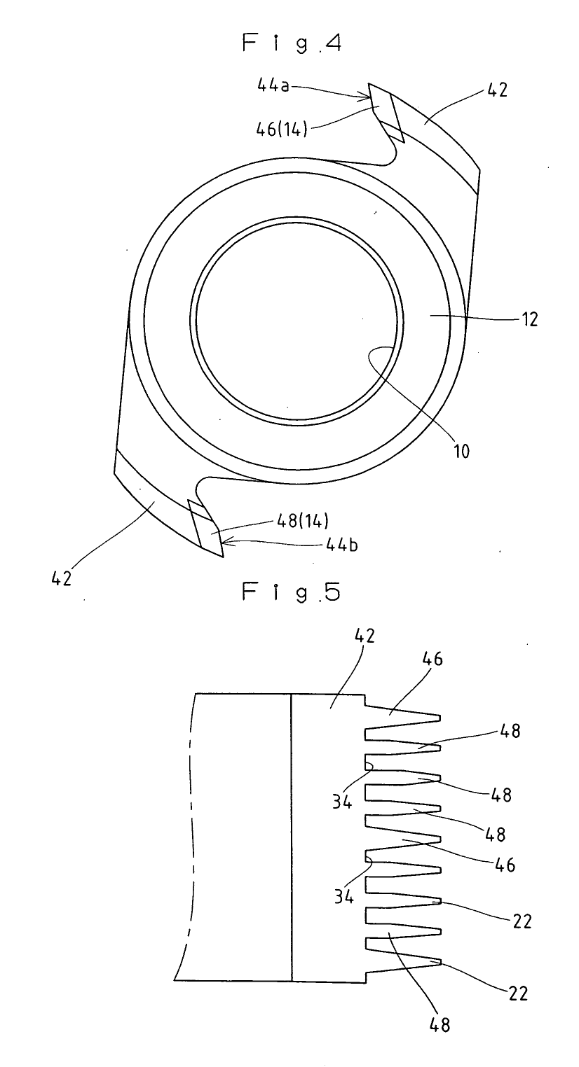

In the above embodiment, an example is given of the case where four cutting blades 14 are provided on an identical rotation trajectory plane. However, as long as at least one main blade 46 is provided on an identical rotation trajectory plane, as illustrated in FIG. 4, two cutting blades 14, 14 (that is, two blade array groups 44a, 44b) may also be provided on an identical rotation trajectory plane, for example. Further, although the main blades 46 and the auxiliary blades 48 are arranged circumferentially alternately on an identical rotation trajectory plane in the above embodiment, the auxiliary blades 48 may also be disposed so as to be continuous circumferentially.

In addition, although the main blades 46 and the auxiliary blades 48 are provided alternately along the rotary shaft R in the above embodiment, the main blades 46 and the auxiliary blades 48 are not necessarily provided alternately, and as illustrated in FIG. 5, the auxiliary blades 48 can also be provided continuously, for example. That is, as long as an auxiliary blade 48 is provided adjacent to the main blade 46 and also the main blades 46 are arranged not to be adjacent to each other in order to enlarge the blade bottom portions 34, there is no problem to have the auxiliary blades 48, 48 become adjacent to each other.

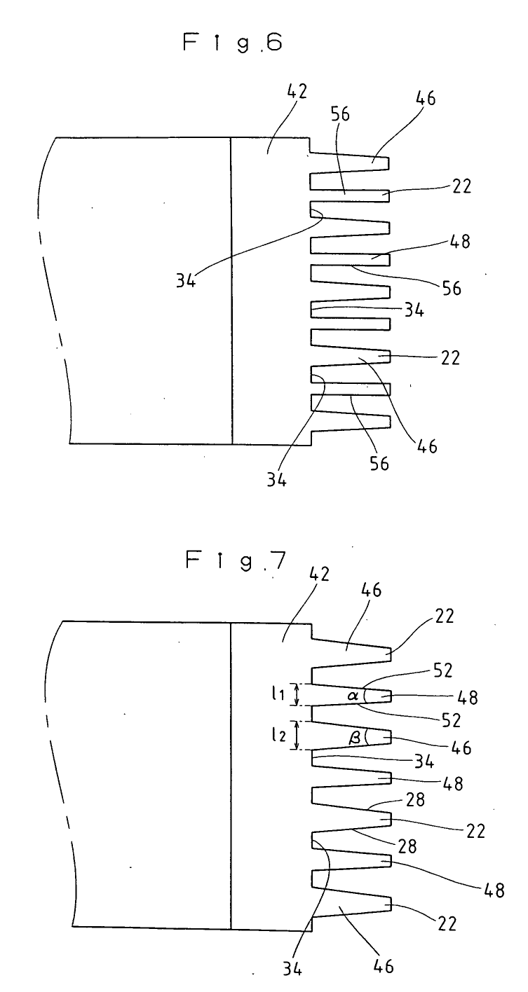

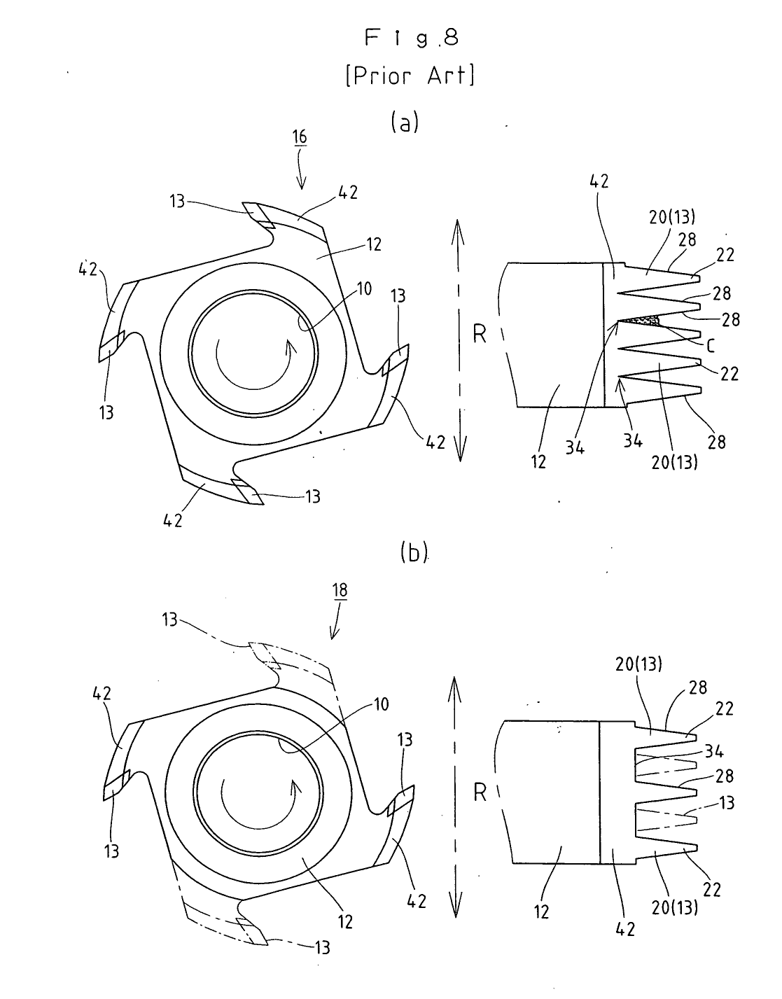

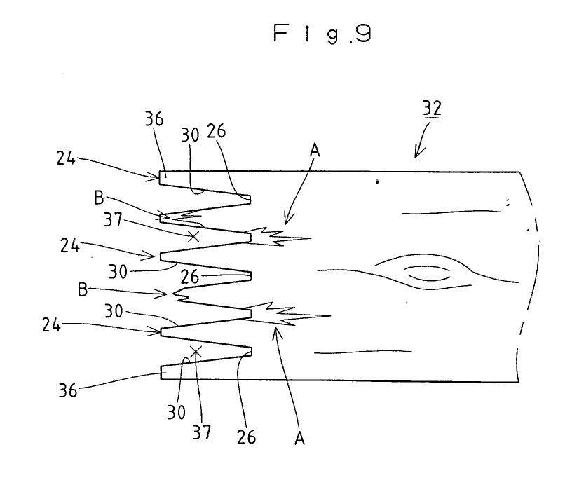

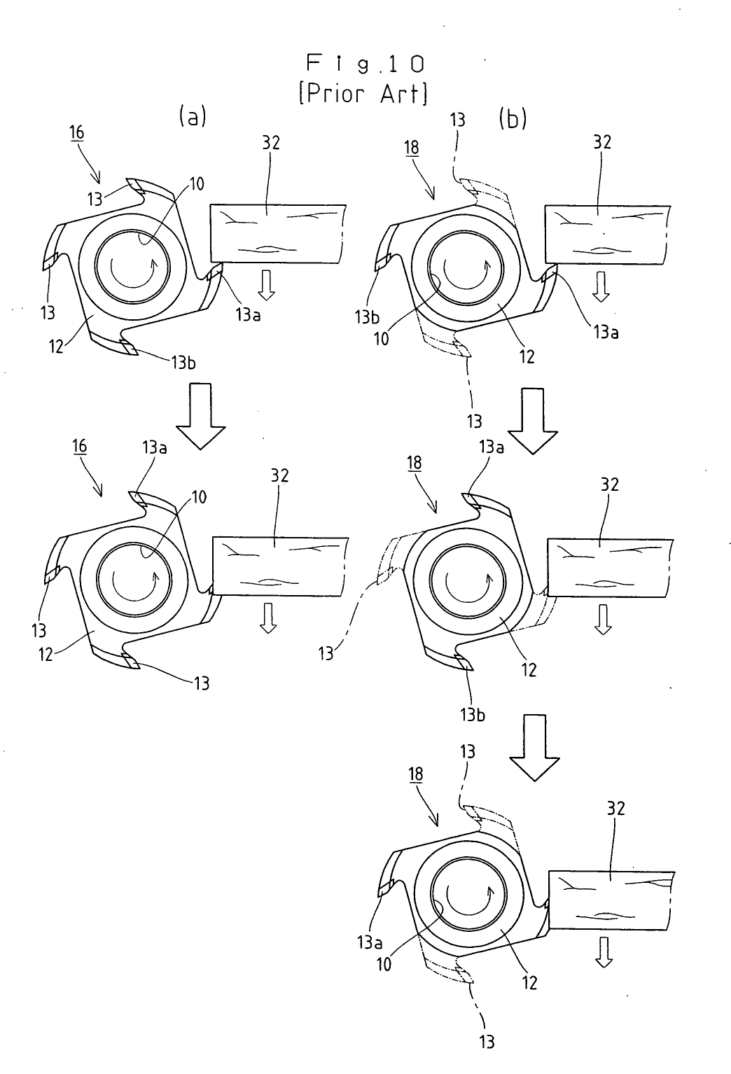

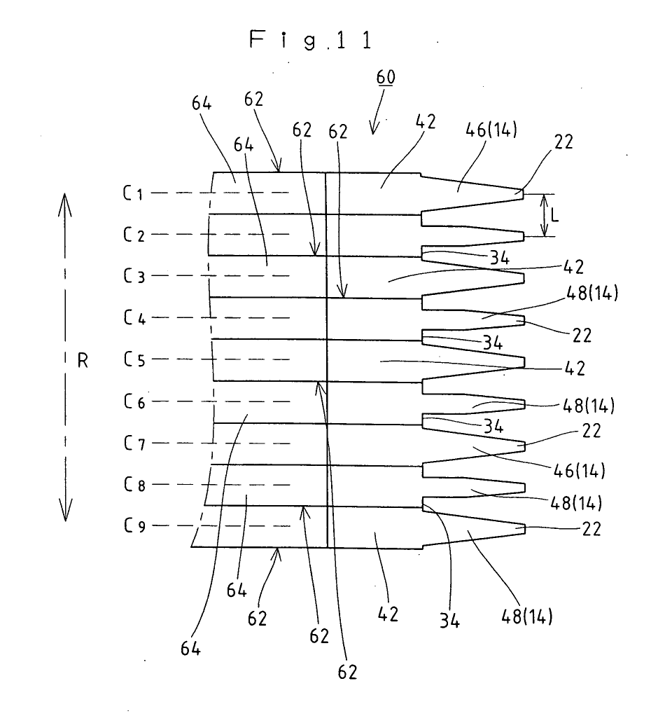

Although the shape of the rake face 54 of the auxiliary blade 48 is formed of the short and small scarf portions 52, 52 and the parallel portions 56 in the above embodiment, as illustrated in FIG. 6, approximately the entire auxiliary blade 48 may also be configured with the parallel portions 56. Further, as illustrated in FIG. 7, it is also possible to form the auxiliary blades 48 in an angle shape similarly to the main blades 46, instead of providing the auxiliary blades 48 with the parallel portions 56. In this case, an angle α made by both the scarf portions 52, 52 of the auxiliary blades 48 is set to be smaller than an angle β made by the scarf portions 28, 28 of the main blades 46. That is, the rake faces 54 of the auxiliary blades 48 can employ other shapes as long as the width dimension l₁ of the portions on the inner diameter side (in the vicinity of the base) parallel to the rotary shaft R is smaller than the width dimension l₂ of the main blades 46.

In the above embodiment, the description is given to the finger joint cutter 40 of a so-called solid type, in which the plurality of cutting blades 14 are arranged for each of the blade array groups 44a to 44d so as to be aligned along the rotary shaft R on the single body 12 having the shaft hole 10 opened therein for inserting a rotary shaft and having a thickness parallel to the rotary shaft R. However, as illustrated in FIG. 11, it is also possible to employ a finger joint cutter 60 of a so-called separate type in which a plurality of unit cutters 62 provided with cutting blades 14 are stacked along the rotary shaft R. This unit cutter 62 is provided with a body 64 having a shaft hole (not shown) for inserting a rotary shaft opened therein and having a thickness identical to the pitch L, and projecting teeth 42 are provided on the outer periphery of the body 64.

Each of the cutting blades 14 is arranged on the corresponding projecting tooth 42 one by one. Further, the finger joint cutter 60 is configured by stacking the plurality (nine, in this modification) of the body 64 in such a manner that the cutting blades 14 are aligned along the rotary shaft R to constitute the blade array groups 44a to 44d. The finger joint cutter 60 according to this modification is also configured in such a manner that each of the cutting blades 14 is aligned in an identical phase to allow the cutting blades 14 to cut into a material 32 to be cut at the same time. Regarding the positions of arrangement of main blades 46 and auxiliary blades 48, similarly to the above embodiment, the auxiliary blades 48 are provided adjacent to the main blades 46 along the rotary shaft R, with the main blades 46 being provided not to be adjacent to each other, and blade bottom portions 34 are set to have a wide width.

1. A finger joint cutter (40, 60), comprising a plurality of blade array groups (44a, 44b, 44c, 44d) made of a plurality of cutting blades (14) aligned at a predetermined pitch (L) along a rotary shaft (R), the cutting blades (14) of each blade array group (44a, 44b, 44c, 44d) in rotation cutting into an end portion of a material (32) to be cut per blade array group (44a, 44b, 44c, 44d) at a same time and thereby shaving a plurality of joint fingers (24) aligned at an identical pitch (L) at the end portion of the material (32) to be cut, wherein
the cutting blades (14) are either a main blade (46) shaving a valley portion (26) and a slope portion (30) of the joint fingers (24) or an auxiliary blade (48) shaving in proximity to the valley portion (26) of the joint fingers (24),
the main blade (46) has a rake face (50) in an angle shape being tapered off towards an outer diameter,
the auxiliary blade (48) is set to have a rake face (54) with a width dimension (l₁) parallel to the rotary shaft (R) in a portion on an inner diameter side being smaller than a width dimension (l₂) parallel to the rotary shaft (R) in a portion on the inner diameter side in the rake face (50) of the main blade (46),
the pitch (L) is set to be not less than the width dimension (l₂) of the main blade (46), and
the main blade (46) is provided to be adjacent to the auxiliary blade (48) along the rotary shaft (R) and also not to be adjacent to the main blade (46) with each other along the rotary shaft (R).

2. The finger joint cutter according to claim 1, wherein the blade array groups (44a, 44b, 44c, 44d) have the plurality of cutting blades (14) configured integrally and arranged on an outer periphery of a main body (12) having a shaft hole (10) for inserting a rotary shaft opened therein for each of the blade array groups (44a, 44b, 44c, 44d).

3. The finger joint cutter according to claim 1, wherein the cutting blades (14) are provided individually on outer peripheries of unit cutters (62) having a shaft hole for inserting a rotary shaft opened therein and having a thickness identical to the pitch (L), and a plurality of the unit cutters (62) are stacked to constitute the blade array groups (44a, 44b, 44c, 44d) with each of the cutting blades (14) being aligned along the rotary shaft (R).

4. The finger joint cutter according to any one of claims 1 through 3, wherein the main blade (46) and the auxiliary blade (48) have a blade bottom portion (34) defined therebetween with a width dimension (l₃) parallel to the rotary shaft (R) being set to be larger than a width dimension (l₄) at blade ends (22) of the main blade (46) and the auxiliary blade (48) parallel to the rotary shaft (R).
